(19) United States
(12) Patent Application Publication
(10) Pub. No.: US 2021/0212272 A1
(43) Pub. Date: Jul. 15, 2021

(54) ILLUMINATION CONTROL IN HORTICULTURE USING FLUORESCENT DYES

(71) Applicant: MOLECULED Ltd., Herzeliya (IL)

(72) Inventors: Daniel Aronov, Netanya (IL); Simon Litsyn, Tel Aviv (IL)

(73) Assignee: MOLECULED Ltd., Herzeliya (IL)

(21) Appl. No.: 16/740,444

(22) Filed: Jan. 12, 2020

(51) Int. Cl. A01G 9/24; F21V 9/32; A01G 9/22; C09D 11/50; C09K 11/06

(52) U.S. Cl. CPC A01G 9/249; F21V 9/32; C09K 11/06; A01G 9/24; C09D 11/50; A01G 9/22

(57) ABSTRACT

Color conversion units and inks for horticultural applications as well as corresponding growing facilities and methods are provided. Color conversion units comprise structural element(s) positioned between natural and/or artificial illumination source(s) and horticultural crop(s), and fluorescent dye(s) embedded in and/or painted on the structural element(s) and configured to convert radiation within absorption range(s) in the specified spectrum into emitted radiation within emission range(s) that are at longer wavelengths than the absorption range(s) and are more readily used by the crop plants and/or modify their growing conditions. Illumination control may be achieved by controlling the types and spatial spread of the dyes, to modify the illumination spectra controllably. For example, dyes may be used to convert ultraviolet, blue and/or green radiation into red radiation which is used better by the plants and/or into growth signals, e.g. in the infrared, that modify plant growth patterns, such as initiating flowering.

### BACKGROUND OF THE INVENTION

### 1. Technical Field

The present invention relates to the field of controlling illumination in horticulture, and more particularly, to using fluorescent dyes to control natural and/or artificial illumination.

### 2. Discussion of Related Art

Illumination is fundamental to plant growth, enabling photosynthesis and providing plant growth signals.

### SUMMARY OF THE INVENTION

The following is a simplified summary providing an initial understanding of the invention. The summary does not necessarily identify key elements nor limit the scope of the invention, but merely serves as an introduction to the following description.

One aspect of the present invention provides a color conversion unit for horticultural applications, the color conversion unit comprising: at least one structural element, configured to be positioned between at least one illumination source having a specified spectrum and a horticultural crop, and at least one fluorescent dye embedded in the at least one structural element, the at least one fluorescent dye configured to convert radiation within at least one absorption range of the specified spectrum into emitted radiation within at least one emission range that is at longer wavelengths than the at least one absorption range.

One aspect of the present invention provides a color conversion ink for horticultural applications, the color conversion ink comprising at least one fluorescent dye configured to convert radiation within at least one absorption range of a specified illumination spectrum into emitted radiation within at least one emission range that is at longer wavelengths than the at least one absorption range, wherein the color conversion ink is configured to be paintable on at least one structural element, configured to be positioned between at least one illumination source having the specified illumination spectrum and a horticultural crop; and/or wherein the color conversion ink is configured to be paintable on the at least one illumination source illuminating the horticultural crop.

One aspect of the present invention provides a method of improving crop illumination in horticultural applications, the method comprising: using at least one fluorescent dye to convert radiation within at least one absorption range of a specified illumination spectrum into emitted radiation within at least one emission range that is at longer wavelengths than the at least one absorption range, and associating the at least one fluorescent dye with at least one structural element, configured to be positioned between at least one illumination source having the specified illumination spectrum and a horticultural crop.

These, additional, and/or other aspects and/or advantages of the present invention are set forth in the detailed description which follows; possibly inferable from the detailed description; and/or learnable by practice of the present invention.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1A is a high-level schematic illustration of a crop growing system with color conversion unit(s) for horticultural applications, according to some embodiments of the invention.

FIGS. 1B and 1C provide high-level schematic examples for spectrum conversion with disclosed color conversion units and/or color conversion inks, according to some embodiments of the invention.

FIG. 1D is a high-level schematic example of specific peak conversions that may be achieved by certain disclosed color conversion dyes, according to some embodiments of the invention.

FIG. 1E is a high-level schematic example for spectrum conversions that provide illumination that is closer to the natural habitat and is adjusted for shade, according to some embodiments of the invention.

FIG. 2 is a high-level flowchart illustrating a method, according to some embodiments of the invention.

### DETAILED DESCRIPTION OF THE INVENTION

In the following description, various aspects of the present invention are described. For purposes of explanation, specific configurations and details are set forth in order to provide a thorough understanding of the present invention. However, it will also be apparent to one skilled in the art that the present invention may be practiced without the specific details presented herein. Furthermore, well known features may have been omitted or simplified in order not to obscure the present invention. With specific reference to the drawings, it is stressed that the particulars shown are by way of example and for purposes of illustrative discussion of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before at least one embodiment of the invention is explained in detail, it is to be understood that the invention is not limited in its application to the details of construction and the arrangement of the components set forth in the following description or illustrated in the drawings. The invention is applicable to other embodiments that may be practiced or carried out in various ways as well as to combinations of the disclosed embodiments. Also, it is to be understood that the phraseology and terminology employed herein are for the purpose of description and should not be regarded as limiting.

Unless specifically stated otherwise, as apparent from the following discussions, it is appreciated that throughout the specification discussions utilizing terms such as “processing”, “computing”, “calculating”, “determining”, “enhancing”, “deriving” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

Embodiments of the present invention provide efficient and economical methods and mechanisms for enhancing illumination efficiency on greenhouses and thereby provide improvements to the technological field of horticulture. Color conversion units and inks for horticultural applications as well as corresponding growing facilities and methods are provided. Color conversion units comprise structural element(s) positioned between natural and/or artificial illumination source(s) and horticultural crop(s), and fluorescent dye(s) embedded in and/or painted on the structural element(s) and configured to convert radiation within absorption range(s) in the specified spectrum into emitted radiation within emission range(s) that are at longer wavelengths than the absorption range(s) and are more readily used by the crop plants and/or modify their growing conditions. Illumination control may be achieved by controlling the types and spatial spread of the dyes, to modify the illumination spectra controllably. For example, dyes may be used to convert ultraviolet, blue and/or green radiation into red radiation which is used better by the plants and/or into growth signals, e.g. in the infrared, that modify plant growth patterns, such as initiating flowering. Advantageously, disclosed dyes in color conversion units and inks may be selected and/or controlled to create a customized spectrum from a given illumination, such as sunlight, with or without use of additional illumination sources. The spectrum may be customized to specific applications, and to modify, control or enhance specific parameters, such as plant morphology, plant reactions to environmental factors, crop uniformity, quality of yield, time of flowering and other parameters.

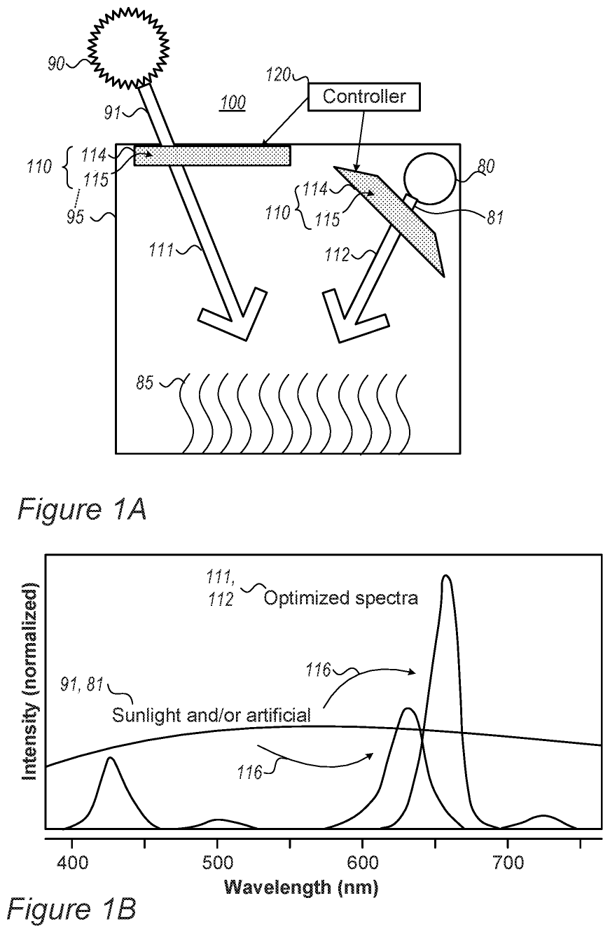

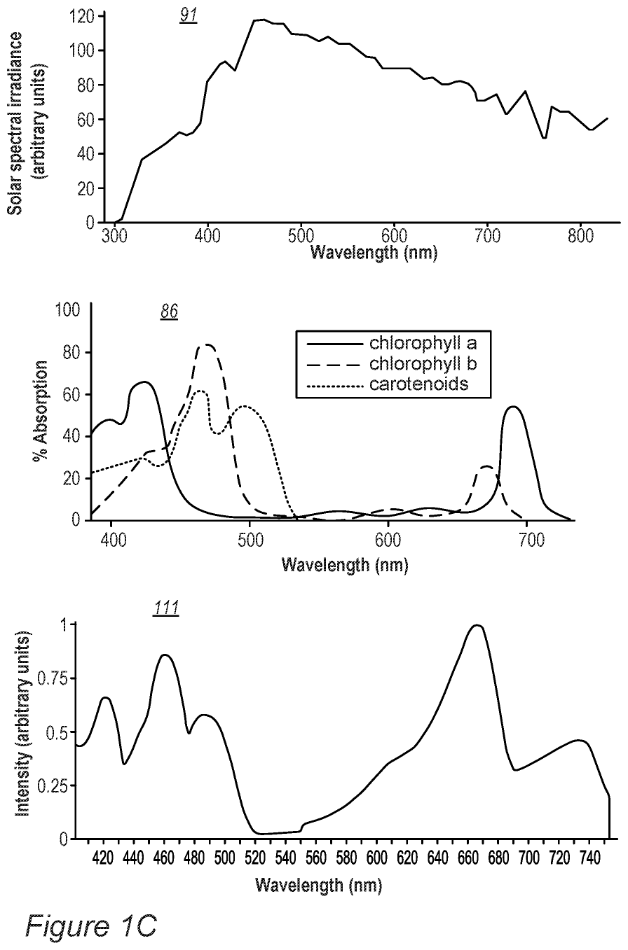

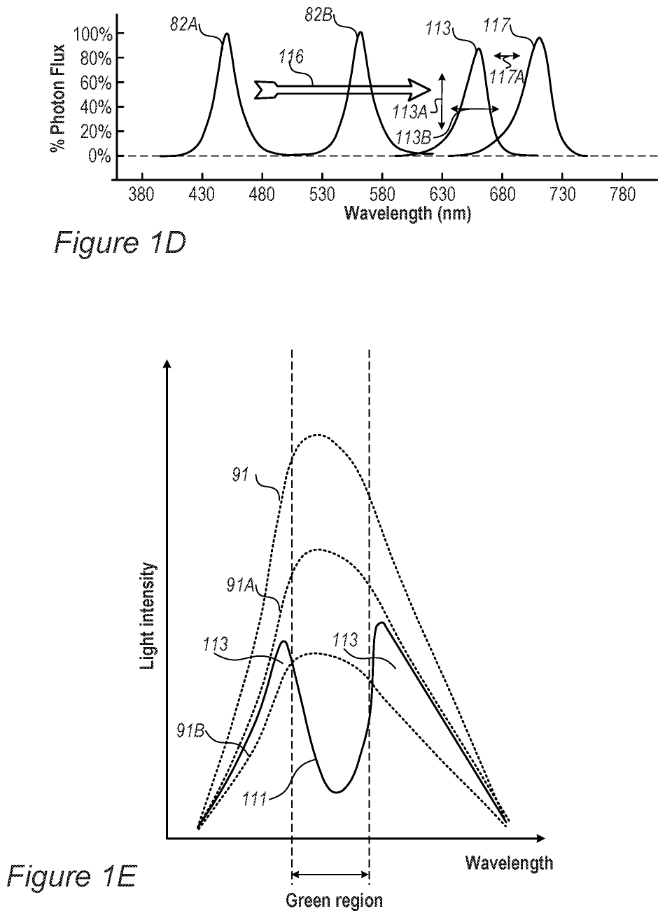

FIG. 1A is a high-level schematic illustration of a crop growing system 100 with color conversion unit(s) 110 for horticultural applications, according to some embodiments of the invention. Crop growing system 100, such as a greenhouse 95, may comprise one or more color conversion unit(s) 110, associated with natural illumination source 90 only (e.g., sunlight) and/or associated with at least one artificial illumination source 80.

Color conversion unit 110, for horticultural applications, may comprise (i) at least one structural element 114, configured to be positioned between at least one illumination source having a specified spectrum (e.g., natural illumination source 90 and/or artificial illumination source 80) and a horticultural crop 85, and (ii) at least one fluorescent dye 115 (indicated schematically) embedded in structural element(s) 114 and/or painted upon structural element(s) 114, e.g., if dye 115 is configured as a color conversion ink (not illustrated). Fluorescent dye(s) may be configured to convert radiation within at least one absorption range of the specified spectrum (91, 81, corresponding to natural and artificial sources, respectively) into emitted radiation within at least one emission range (111, 112, corresponding to natural and artificial sources, respectively) that is at longer wavelengths than the at least one absorption range.

For example, any of the disclosed dyes may be used to yield the required conversion of spectra. The illumination spectrum (including sun and/or artificial illumination) may be modified to correspond more closely to the spectral requirements of the crop plants. Artificial light may be used in greenhouses as well as a supplementary system. Various disclosed embodiments may be applied to indoor horticulture, e.g., modifying the spectral distribution of artificial illumination sources such as LEDs (light emitting diodes). For example, one or more LED sources may be modified by one or more color conversion unit(s) 110, to yield one or more modified spectral distributions. In certain embodiments, one type of LED (e.g., blue LEDs) may be used to provide multiple spectral distributions. Multiple color conversion units 110 may be used to yield different spectra and/or different illumination intensities, e.g., some of color conversion units 110 may use certain disclosed dyes 115 while other color conversion units 110 may use different disclosed dyes 115 and/or some of color conversion units 110 may be patterned while other color conversion units 110 may be not-patterned or patterned differently.

In a schematic, non-limiting example, FIGS. 1B and 1C provide high-level schematic examples for spectrum conversion with disclosed color conversion units 110 and/or color conversion inks, according to some embodiments of the invention. FIG. 1B illustrates schematically an illumination spectrum of sunlight radiation 91 and/or artificial illumination 81, alongside optimized spectra 111, 112, respectively, which comprise specific peaks at wavelength ranges that are readily absorbed by the crop plant, converted 116 from parts of the illumination spectrum that have shorter wavelengths, and are less readily exploited by the crop plants. FIG. 1C illustrates schematically a solar radiation spectrum 91, absorption spectra 86 of chlorophylls a and b and carotenoids in plants and optimized spectrum 111 which may be converted (116) from solar illumination spectrum 91 by disclosed color conversion units 110 and/or color conversion inks to fit the plant absorption curve more closely. It is noted that other plant pigments may be targeted, e.g., phytochromes in various states (R—red, IR—infrared, FR—far red, etc.), influencing thereby the plants' responses to environmental conditions such as daylength responses related to developmental stages of the plants, yielding e.g., growth or flowering induction.

In certain embodiments, dyes 115 may be selected to convert UV (ultraviolet) radiation into blue radiation, both protecting the plants from UV and possibly providing growth signals in the blue range, related, e.g., to flowering. Adjusting illumination (111 and/or 112) intensities in the blue region and in the red region and providing proper balance between them using dyes 115 may also enhance plant growth.

Dyes 115 may further be selected to adjust color ratios of illumination 111 and/or 112 such as the blue to green color ratio or the red to infrared (or far red) color ratio, affecting the phytochrome photoreceptors (e.g., phytochrome B switching between the biologically inactive form—Pᵣ, at λₘₐₓ=660 nm, and the biologically active form—P_{fr}, at λₘₐₓ=730 nm)—which regulate plant growth factors such as photomorphogenesis (e.g., elongation), germination and flowering of plants.

In certain embodiments, dyes 115 may be selected to adjust the illumination spectrum to modify plant reactions to environmental factors, e.g., induce plant defenses against viruses and/or pests. The adjustment of the illumination may be earned out with respect to, or in association with crop genetics that determine the degree to which specific plant reactions are sensitive to illumination characteristics.

In certain embodiments, dyes 115 may further be selected or controlled to modify heat transfer to the plants, by converting near IR radiation to far IR radiation, reducing heat load.

Clearly, disclosed color conversion units 110 and/or color conversion inks do not necessarily yield the most fitting spectrum with respect to the spectrum absorbed by the crop plants, but merely make the illumination spectrum, more similar to the spectrum absorbed by the crop plants. As a result, using the dyes may supplement and/or modify natural daylight to enhance photosynthesis by providing more usable illumination to the crop, to improve growth and quality of plants grown in greenhouses and/or under artificial illumination. In certain embodiments, any of the disclosed color conversion dyes may be used in addition to filtering dyes, such as UV or/and IR filtering dyes, used in current solutions to protect crops. In certain embodiments, color conversion dyes may be selected to absorb radiation in the UV and emit radiation which is more ready used by the crop plant and/or converted by additional color conversion dyes into such radiation.

FIG. 1D is a high-level schematic example of specific peak conversions that may be achieved by certain disclosed color conversion dyes, according to some embodiments of the invention. Given a specific peak 82 in natural and/or artificial radiation 91, 81, respectively, one or more of the disclosed color conversion dyes may be selected to convert (116) one or more peak 82A (e.g., blue) and/or 82B (e.g., green) (or possibly a UV peak, not shown)—into peaks 113, 117 at longer wavelengths (e.g., reds, or possibly infrared; in case of UV conversion possibly into blue peaks), which may be more readily absorbed by the crop plants and/or provide plant growing signals. For example, peak 113 was shown to increase anthocyanin production in plants, which may affect their growth (e.g., delaying flowering in short-day plants) and other characteristics such as color and nutritional value, while peak 117 is known to lengthen the dark period to encourage the flowering process in short day plants. The height 113A and width 113B of each peak, as well as its wavelength range 117A may be fine-tuned and/or modify by the selection of color conversion dyes, and/or control thereof, as disclosed below.

In certain embodiments, structural element(s) 114 may comprise at least one greenhouse structural element, possibly walls and/or roof thereof, and/or other structural elements of greenhouse 95 and/or structural elements added thereto. In certain embodiments, structural element(s) 114 may be attachable to any of the greenhouse structural elements, and/or configurations of color conversion dyes may be painted upon the greenhouse structural elements. Certain embodiments comprise greenhouses 95 with color conversion units 110 within and/or attached to structural elements thereof including roof and/or walls. It is noted that the term “greenhouse” is used herein in its broadest sense as any structure or growing facility used to grow plants.

Certain embodiments comprise illuminator(s) 80 comprising color conversion unit(s) 110 within and/or attached to at least one structural element of illuminator(s) 80 (shown very schematically in FIG. 1A).

Certain embodiments comprise color conversion ink(s) for horticultural applications, comprising fluorescent dye(s) 115 configured to convert radiation within at least one absorption range of a specified illumination spectrum into emitted radiation within at least one emission range that is at longer wavelengths than the at least one absorption range. The color conversion ink may be configured to be paintable on at least one structural element 114, configured to be positioned between at least one illumination source having the specified illumination spectrum and horticultural crop 85. Alternatively or complementarily, the color conversion ink may be configured to be paintable on at least one illumination source 80 that illuminates horticultural crop 85. Fluorescent dye(s) 115 may be selected to convert blue and/or green light into red light and/or convert ultraviolet light into visible light—as non-limiting example, and/or to perform any other color conversion 116 as disclosed herein.

In various embodiments, the illumination source may comprise sunlight illumination 91, and fluorescent dye(s) 115 may be selected to convert the solar illumination spectrum into a spectrum 111 that is more similar to an absorption spectrum of the crop. In various embodiments, the illumination source may comprise artificial illumination, and fluorescent dye(s) 115 may be selected to convert the artificial illumination spectrum into a spectrum 112 that is more similar to an absorption spectrum of the crop. For example, fluorescent dye(s) 115 may be selected to convert blue and/or green light into red light and/or convert ultraviolet light into visible light—using one or more dyes to carry out conversion 116 (illustrated very schematically in FIG. 1D).

In various embodiments, the absorption range(s) may be selected as one or more spectral range(s) in which radiation is stronger than a capability of the crop plants to absorb the radiation, during at least one period, and the emission range(s) may be selected as one or more spectral range(s) in which radiation is weaker than a capability of the crop plants to absorb, during the same at least one period. The periods may be midday with high solar radiation, mornings or evening with low solar radiation, or dependent of weather conditions. Dye(s) 115 may possibly be controlled with respect to the time of day, season and/or weather conditions (see below).

In certain embodiments, absorption range(s) and the emission range(s) may be selected to modify an illumination-related growth signal for crop 85, such as growth period, flowering period, day-length, etc.

It is noted that dyes 115 may be used in various ways. For example, in greenhouse 95, dyes 115 may be integrated in at least parts of the greenhouse material, e.g., in the roof or walls. Alternatively or complementarily, dyes 115 may be integrated in the structural material or provided, e.g., as foil or film, that can be attached to the structure (e.g., as covering foils or stickers, made of e.g., ink, plastics, glass, textile as well as material supporting liquids or gels that include dyes 115). Dyes 115 in any of these structural materials, e.g., structural elements 114, may be patterned to provide only partial color conversion 116, and/or their patterns may be controlled to modify the effect of dyes 115 under various conditions, e.g., the coverage of dyes 115 may be increased or decreased depending on weather conditions and/or plant growth stages. In artificial light sources 80, dyes 115 may be integrated in the light source itself, e.g., in glass tubes or casing enclosing the illumination source (e.g., LEDs) in operation. Integration may be carried out in one or more layers, possibly each comprising different dyes 115 and/or different mix of dyes 115, which may also be controllable. Dyes 115 may be used in form of ink applied to respective structure 114 and/or illumination source 80. Dyes 115 may be used in a patterned manner, converting only part of the illumination to yield a specified mix of original (natural and/or artificial) and modified (converted) illumination. The dyes may be embedded in various types of matrix, e.g., solid or fluid, rigid or flexible, depending on application.

In certain embodiments, crop growing system 100 may further comprise a closed-loop controller 120 (see FIG. 1A) configured to modify at least one fluorescent dye 115 or composition or spatial extent thereof, and/or modify parameters of at least one structural element 114 with respect to plant requirements and artificial illumination source parameters. One or more artificial illumination source(s) 80 may be used in addition to sunlight illumination 90. Color conversion unit 110 may be associated with at least one of artificial and sunlight illumination sources 80, 90, respectively. Closed-loop controller 120 may be configured to modify fluorescent dye(s) 115 and/or modify parameters of structural element(s) 114 with respect to plant requirements and sunlight and artificial illumination source parameters.

The composition of dyes 115 may be modified in different ways during the illumination period, which may be short-term (e.g., during a day) and/or long-term (e.g., during the growing season). Varying natural illumination conditions may be compensated for by using one or more combinations of corresponding dyes 115; for example, decreased illumination levels (e.g., during morning, evening or overcast weather) may be compensated for by modifying the spectral distribution to one more fitting the plants' needs. Clearly, artificial illumination 80 may be added to natural illumination 90, and may likewise be modified by disclosed dyes 115.

The illumination of crop 85 may be controlled and modified using dyes 115. For example, closed-loop control 120 may be implemented by sensing the illumination intensity and/or the illumination quality (e.g., spectral distribution) and modifying the types and/or coverage of dyes 115 used to modify the spectrum accordingly, e.g., by increasing or decreasing coverage of the light source by structural elements 114 with dyes 115 (e.g., foil), adding or removing dye layers, etc. The control of illumination may include adding artificial illumination 80, optionally controlled as well using disclosed dyes 115. Illumination control may further comprise manipulating illumination signals to the grown plants through modification of the illumination spectrum, such as day length (light periods), dark periods etc. It is noted that the modification of the illumination spectrum may be configured to increase the overall available illumination to the plants without necessarily changing the overall intensity of illumination, by moving radiation from spectral regions that are not or less used by the plants, to spectral regions that are, or more, used by the plants—as disclosed above.

It is noted that modifying the spectral distribution may be used to modify plant contents, e.g., in fruit, inflorescence or other plant material. For example, the composition and relative abundance of cannabinoids and terpenes in cannabis may be influenced by the spectral distribution of the illumination during different periods of plant growth and flowering. Various embodiments may be applied to growing cannabis to improve yield and quality, as well as to modify plant development and composition of the inflorescences.

FIG. 1E is a high-level schematic example for spectrum conversions that provide illumination that is closer to the natural habitat and is adjusted for shade, according to some embodiments of the invention. In certain embodiments, crop growing system 100 may be configured to simulate the illumination profile of the crop plants in their natural habitat—to improve crop quality and horticultural performance. Moreover, shade that is required or used for certain crops, changes not only the illumination intensity, but also its quality and spectral distribution. Crop growing system 100 may be configured to maintain specified illumination characteristics, such as spectral distribution, even when shading is applied, and/or to at least partly replace the need for shade. In certain embodiments, system 100 may be configured to apply shading by reducing the illumination intensity at specified spectral regions, e.g., in which photosynthesis efficiency is relatively low. Such shading may reduce the heat load on the plants but allow them to maintain photosynthesis. It may be advantageous compared to natural or mechanical shading that reduces significantly the illumination available for plant photosynthesis. Alternatively or complementarily, system 100 may be configured to compensate for reduction of illumination intensity in spectral regions in which photosynthesis efficiency is high, e.g., due to natural or artificial shading—by shifting radiation wavelengths into spectral regions in which photosynthesis efficiency is high—making such radiation available again for plant photosynthesis.

FIG. 1E schematically illustrates solar radiation spectrum 91, maximal and average shaded spectral distributions 91A, 91B (achieved naturally e.g., by clouds, or artificially, e.g., by shade nets), respectively, and modified spectral distribution 111 achieved through embodiments of system 100 with color conversion 116. As illustrated, disclosed color conversion 116 provides a more drastic reduction in the maximal light intensity (in the green region, which is not well-utilized by crop plants) while enhancing useful radiation 113 outside the green region (which is utilized better by the plants, see, e.g., FIGS. 1C and 1B). Advantageously, modified illumination 111 may be configured to improve the spectral quality of the plant illumination, affecting the plants' morphology, reactions to environmental factors, physiology and growth rate. In addition to reducing the light intensity or total spectral irradiance (radiation incident on a flat surface per unit area), disclosed embodiments attenuate sunlight in a wavelength-specific manner. Certain embodiments comprise using disclosed color conversion 116 in conjugation with shading means (e.g., films, nets, screens, etc.) that may be adapted to achieve a required level of shading that can be best modified by color conversion unit(s) 110 to yield optimized illumination 111. For example, disclosed embodiments may be configured to achieve a relatively constant level of effective illumination through the day.

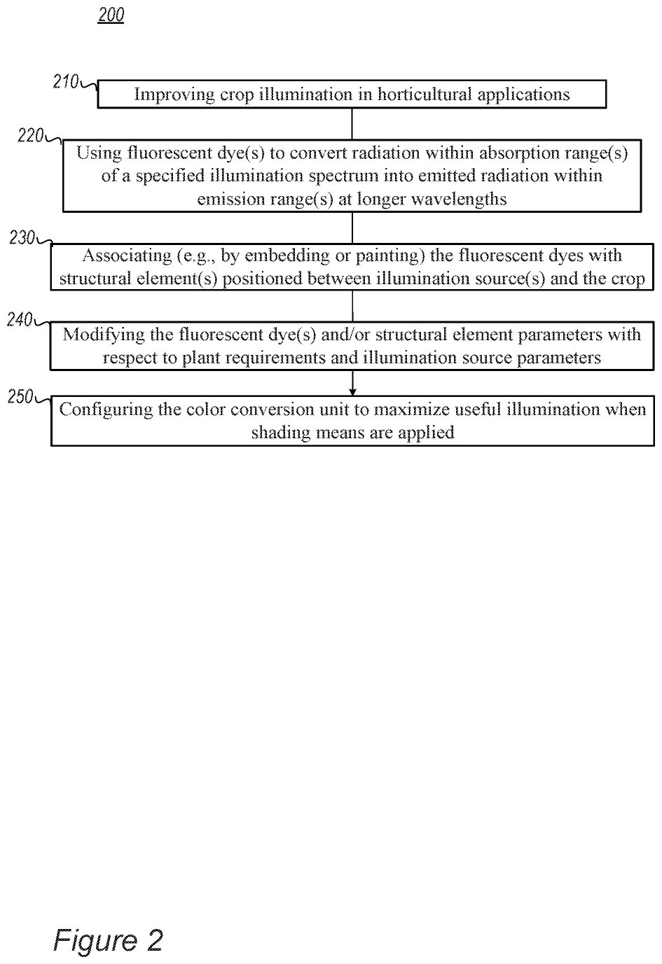

FIG. 2 is a high-level flowchart illustrating a method 200, according to some embodiments of the invention. The method stages may be carried out with respect to crop growing system 100 described above, which may optionally be configured to implement method 200. Method 200 may be at least partially implemented by at least one computer processor, e.g., in closed-loop controller 120. Certain embodiments comprise computer program products comprising a computer readable storage medium having computer readable program embodied therewith and configured to carry out the relevant stages of method 200. Method 200 may comprise the following stages, irrespective of their order.

Method 200 may comprise of improving crop illumination in horticultural applications (stage 210), by using at least one fluorescent dye to convert radiation within at least one absorption range of a specified illumination spectrum into emitted radiation within at least one emission range that is at longer wavelengths than the at least one absorption range (stage 220), and associating the at least one fluorescent dye with at least one structural element, configured to be positioned between at least one illumination source having the specified illumination spectrum and a horticultural crop (stage 230). For example, associating 230 may be carried out by embedding the at least one fluorescent dye in the at least one structural element and/or painting the at least one fluorescent dye onto the at least one structural element. Method 200 may further comprise modifying the at least one fluorescent dye and/or parameters of the at least one structural element with respect to plant requirements and illumination source parameters, e.g., controlled using computer program products (stage 240). In certain embodiments, method 200 further comprises configuring the color conversion unit to maximize useful illumination when shading means are applied (stage 250).

Candidate dyes 115 include any of the dyes disclosed in U.S. Patent Application Publication No. 2018/0246371, which is incorporated herein by reference in its entirety. Non-limiting examples for dyes are provided below.

In certain embodiments, coumarin-based dyes may be used to convert UV radiation to radiation in the visible range. In certain embodiments, rhodamine-based dyes may be used to convert radiation in the visible range (or possibly near IR radiation) into near IR and/or far IR radiation.

### Examples for Dyes

Disclosed dyes 115 are provided, which may be used to modify a received spectrum by absorption of radiation at some spectral regions to reduce their intensity and emission of radiation at other spectral regions to increase their intensity. Disclosed dyes 115 may be used to convert radiation in the LCD display—possibly in combination with other dyes disclosed herein.

In some embodiments, dye compounds 115 may be represented by the following structure of Formula (A1):

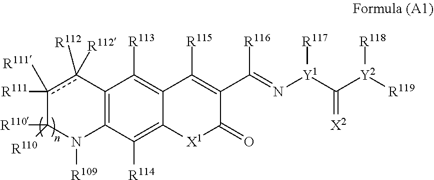

wherein
R¹⁰⁹ is H, alkyl, haloalkyl, heterocycloalkyl, cycloalkyl, aryl or benzyl;
R¹¹⁰ and R^{110′} are each independently H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹¹, R^{111′}, R¹¹² and R^{112′} are each independently absent, H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹³ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁴ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁵ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁶ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁷ is H, alkyl, haloalkyl, heterocycloalkyl, cycloalkyl, aryl or benzyl;
R¹¹⁸ and R¹¹⁹ are each independently H, alkyl, haloalkyl, heterocycloalkyl, cycloalkyl, aryl or benzyl;
X¹ is NR^{a}, S or O;
X² is NR^{a}, S or O
Y¹ is N or CR^{a};
Y² is N or CR^{a};
R^{a} is H, alkyl, haloalkyl, cycloalkyl, heterocycloalkyl, aryl or benzyl;
n is an integer between 0 and 3; and
wherein if there is a double bond between the carbons which are substituted by R¹¹¹, R^{111′}, R¹¹² and R^{112′} —then one of R¹¹¹ and R^{111′} is absent and one of R¹¹² and R^{112′} is absent.

In another embodiment, dye compounds 115 may be represented by the following structure of Formula (A1a):

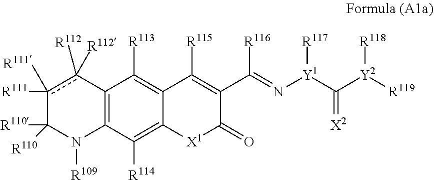

wherein
R¹⁰⁹ is H, alkyl, haloalkyl, heterocycloalkyl, cycloalkyl, aryl or benzyl;
R¹¹⁰ and R^{110′} are each independently H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹¹, R^{111′}, R¹¹² and R^{112′} are each independently absent, H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹³ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁴ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁵ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁶ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁷ is H, alkyl, haloalkyl, heterocycloalkyl, cycloalkyl, aryl or benzyl;
R¹¹⁸ and R¹¹⁹ are each independently H, alkyl, haloalkyl, heterocycloalkyl, cycloalkyl, aryl or benzyl;
X¹ is NR^{a}, S or O;
X² is NR^{a}, S or O
Y¹ is N or CR^{a};
Y² is N or CR^{a};
R^{a} is H, alkyl, haloalkyl, cycloalkyl, heterocycloalkyl, aryl or benzyl; and
wherein if there is a double bond between the carbons which are substituted by R¹¹¹, R^{111′}, R¹¹² and R^{112′}—then one of R¹¹¹ and R^{111′} is absent and one of R¹¹² and R^{112′} is absent.

In some embodiments, dye compounds 115 may be represented by the following structure of Formula (A2):

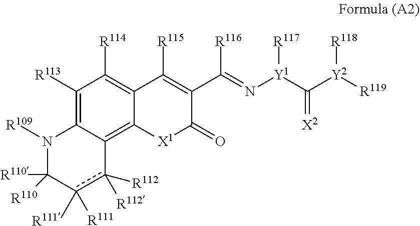

wherein
R¹⁰⁹ is H, alkyl, haloalkyl, heterocycloalkyl, cycloalkyl, aryl or benzyl;
R¹¹⁰ and R^{110′} are each independently H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹¹, R^{111′}, R¹¹² and R^{112′} are each independently absent, H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹³ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁴ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁵ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁶ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁷ is H, alkyl, haloalkyl, heterocycloalkyl, cycloalkyl, aryl or benzyl;
R¹¹⁸ and R¹¹⁹ are each independently H, alkyl, haloalkyl, heterocycloalkyl, cycloalkyl, aryl or benzyl;
X¹ is NR^{a}, S or O;
X² is NR^{a}, S or O
Y¹ is N or CR^{a};
Y² is N or CR^{a};
R^{a} is H, alkyl, haloalkyl, cycloalkyl, heterocycloalkyl, aryl or benzyl; and
wherein if there is a double bond between the carbons which are substituted by R¹¹¹, R^{111′}, R¹¹² and R^{112′}—then one of R¹¹¹ and R^{111′} is absent and one of R¹¹² and R^{112′} is absent.

In some embodiments, dye compounds 115 may be represented by the following structure of Formula (A3):

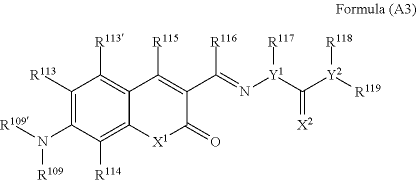

wherein
R¹⁰⁹ and R^{109′} are each independently is H, alkyl, haloalkyl, heterocycloalkyl, cycloalkyl, aryl or benzyl;
R¹¹³ and R^{113′} are each independently is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁴ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁵ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁶ is H, alkyl, haloalkyl, cycloalkyl, heterocycloalkyl, aryl, benzyl, halide, NO₂, OR^{a}, N(R^{a})₂, COR^{a}, CN, CON(R^{a})₂, CO(N-heterocycle) or COOR^{a};
R¹¹⁷ is H, alkyl, haloalkyl, heterocycloalkyl, cycloalkyl, aryl or benzyl;
R¹¹⁸ and R¹¹⁹ are each independently H, alkyl, haloalkyl, heterocycloalkyl, cycloalkyl, aryl or benzyl;
X¹ is NR^{a}, S or O;
X² is NR^{a}, S or O
Y¹ is N or CR^{a};
Y² is N or CR^{a}; and
R^{a} is H, alkyl, haloalkyl, cycloalkyl, heterocycloalkyl, aryl or benzyl.

In some embodiments, dye compounds 115 may be selected from the group consisting of compounds A1-1, A1-2, A1-3, A2-1, A2-2 and A3-1, represented by the following structures:

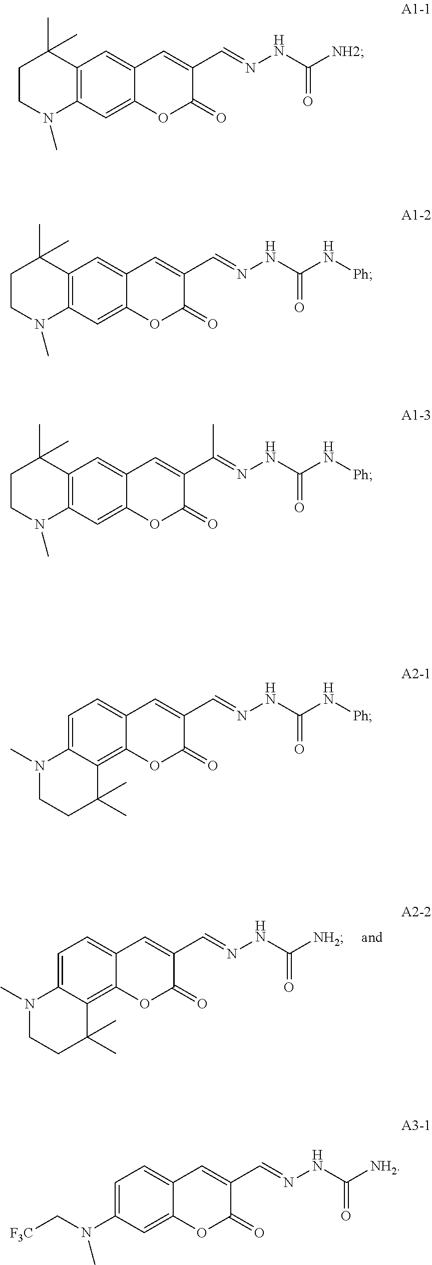

In these six non-limiting examples, Compounds A3-1 and A1-3 absorb violet radiation and emits blue radiation, effectively converting radiation from the violet range to the blue range, while the other Compounds A1-1, A1-2, A2-1 and A2-2 absorb blue radiation and emit green radiation, effectively converting radiation from the blue range to the green range, as illustrated by the data provided in the following Table 1.

TABLE 1
Absorption and emission wavelengths (in EtOH, ethanol),
quantum yield, and FWHM (Full width at half maximum
of the emission) for the exemplified compounds.

| | Absorbance | Emission | Quantum yield | FWHM |
|---|---|---|---|---|
| Compound | EtOH [nm] | EtOH [nm] | [%] | [nm] |
| Compound A1-1 | 447 | 503 | 0.75 | 55 |
| Compound A1-2 | 446 | 510 | 0.72 | 55 |
| Compound A1-3 | 415 | 494 | 0.1 | 68 |
| Compound A2-1 | 443 | 510 | 0.74 | 55 |
| Compound A2-2 | 440 | 505 | 0.75 | 55 |
| Compound A3-1 | 408 | 473 | — | — |

In some embodiments, dye compounds 115 may absorb light in the wavelength range of 350-800 nm. In one embodiment, the absorbance range is 350-500 nm. In another embodiment, the absorbance range is 400-500 nm. In another embodiment, compound A1-1 absorbs light at 447 nm (in Ethanol). In another embodiment, compound A1-2 absorbs light at 446 nm (in Ethanol). In another embodiment, compound A1-3 absorbs light at 415 nm (in Ethanol). In another embodiment, compound A2-1 absorbs light at 443 nm (in Ethanol). In another embodiment, compound A2-2 absorbs light at 440 nm (in Ethanol). In another embodiment, compound A3-1 absorbs light at 408 nm (in Ethanol). Each possibility represents a separate embodiment of this invention.

In some embodiments, dye compounds 115 may emit light in the wavelength range of 400-800 nm. In one embodiment, the emission range is 400-550 nm. In another embodiment, compound A1-1 emits light at 503 nm (in Ethanol). In another embodiment, compound A1-2 emits light at 510 nm (in Ethanol). In another embodiment, compound A1-3 emits light at 494 nm (in Ethanol). In another embodiment, compound A2-1 emits light at 510 nm (in Ethanol). In another embodiment, compound A2-2 emits light at 505 nm (in Ethanol). In another embodiment, compound A3-1 emits light at 473 nm (in Ethanol). Each possibility represents a separate embodiment of this invention.

In some embodiments dye compounds 115 may have a quantum yield (QY) of between 0.5-1. In one embodiment, the QY is 0.7-0.9. In another embodiment, compound A1-1 has a QY of 0.75. In another embodiment, compound A1-2 has a QY of 0.72. In another embodiment, compound A1-3 has a QY of 0.1. In another embodiment, compound A2-1 has a QY of 0.74. In another embodiment, compound A2-2 has a QY of 0.75. Each possibility represents a separate embodiment of this invention.

In some embodiments dye compounds 115 may have a Full width at half maximum (FWHM) of emission being between 30-60 nm. In one embodiment, the FWHM is between 50-60 nm. In another embodiment, compound A1-1 has an FWHM of 55 nm. In another embodiment, compound A1-2 has an FWHM of 55 nm. In another embodiment, compound A1-3 has an FWHM of 68 nm. In another embodiment, compound A2-1 has an FWHM of 55 nm. In another embodiment, compound A2-2 has an FWHM of 55 nm. Each possibility represents a separate embodiment of this invention.

A wide range of fluorescent organic molecules may be incorporated in films used in color conversion units 110, such as materials of the xanthene dye family like fluorescein, rhodamine derivatives and coumarin family dyes, as well as various inorganic fluorescent materials. In the following, explicit examples of rhodamine-based dyes 115, are presented in detail, in a non-limiting manner.

Some embodiments of dyes 115 are defined by Formula 1.

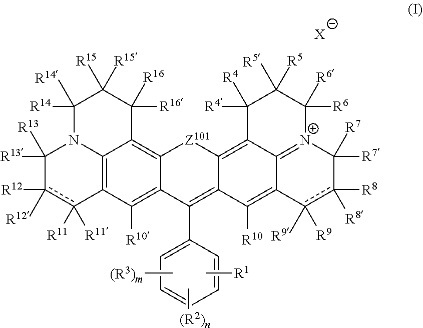

wherein
R¹ is halide, alkyl, haloalkyl, COOR, NO₂, COR, COSR, CON(R)₂, CO(N-heterocycle) or CN;
R² each is independently selected from H, halide, N(R)₂, COR, CN, CON(R)₂, CO(N-heterocycle), NCO, NCS, OR, SR, SO₃H, SO₃M and COOZ;
R³ each is independently selected from H, halide, N(R)₂, COR, CN, CON(R)₂, CO(N-heterocycle), NCO, NCS, OR, SR, SO₃H, SO₃M and COOZ;
R⁴-R⁷, R¹³-R¹⁶, R^{4′}-R^{7′} and R^{13′}-R^{16′} are each independently selected from H, alkyl, alkenyl, alkynyl, epoxide, alkylated epoxide, azide, cycloalkyl, heterocycloalkyl, aryl, benzyl, halide, NO₂, SR, OR, N(R)₂, COR, CN, CON(R)₂, CO(N-heterocycle) and COOR;
R⁸-R⁹, R¹¹-R¹², R^{8′}-R^{9′} and R¹¹-R¹² are each independently selected from absent, H, alkyl, alkenyl, alkynyl, epoxide, alkylated epoxide, azide, cycloalkyl, heterocycloalkyl, aryl, benzyl, halide, NO₂, SR, OR, N(R)₂, COR, CN, CON(R)₂, CO(N-heterocycle) and COOR;
R¹⁰ and R^{10′} are each independently selected from H, alkyl, alkenyl, alkynyl, epoxide, alkylated epoxide, alkylated azide, azide, SO₃H, SO₃M, cycloalkyl, heterocycloalkyl, aryl, benzyl, halide, NO₂, SR, OR, N(R)₂, COR, CN, CON(R)₂, CO(N-heterocycle) and COOR;
R is H, haloalkyl, alkyl, cycloalkyl, heterocycloalkyl, aryl, benzyl, —(CH₂CH₂O)ᵣCH₂CH₂OH, —(CH₂)ₚOC(O)NH(CH₂)_{q}Si(Oalkyl)₃, —(CH₂)ₚOC(O)NH(CH₂)_{q}Si(halide)₃, —(CH₂)ₚOC(O)CH═CH₂, (CH₂)ₚOC(O)C(CH₃)═CH₂, —(CH₂)ₚSi(halide)₃, alkenyl, alkynyl, alkylated epoxide, alkylated azide, azide, or —(CH₂)ₚSi(Oalkyl)₃;
Z is alkyl, haloalkyl, alkenyl, alkynyl, alkylated epoxide, cycloalkyl, heterocycloalkyl, aryl, benzyl, —(CH₂CH₂O)ᵣCH₂CH₂OH, —(CH₂)ₚOC(O)NH(CH₂)_{q}Si(Oalkyl)₃, —(CH₂)ₚOC(O)CH═CH₂, —(CH₂)_{P}OC(O)C(CH₃)═CH₂ or —(CH₂)ₚSi(Oalkyl)₃;
Z¹⁰¹ is O, CR₂ or SiR₂;
M is a monovalent cation;
n and m are each independently an integer between 1-4;
p and q are each independently an integer between 1-6;
r is an integer between 0-10;
X is an anion;
wherein if there is a double bond between the carbons which are substituted by R⁸, R^{8′}, R⁹ and R^{9′}—then R⁸ and R⁹ are absent or R⁸ and R^{9′} are absent or R^{8′} and R⁹ are absent or R^{8′} and R^{9′} are absent; and
wherein if there is a double bond between the carbons which are substituted by R¹¹, R^{11′}, R¹² and R^{12′}—then R¹¹ and R¹² are absent or R¹¹ and R^{12′} are absent or R^{11′} and R¹² are absent or R^{11′} and R^{12′} are absent.

Some embodiments of dyes 115 are defined by Formula 2.

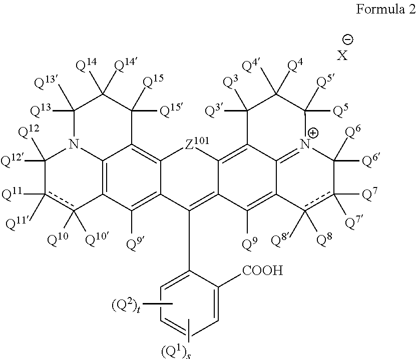

wherein
Q¹ each is independently selected from H, halide, haloalkyl, tosylate, mesylate, SO₂NHQ, triflate, isocyante, cyanate, thiocyanate, isothiocyanate, COQ, COCl, COOCOQ, COOQ, OCOQ, OCONHQ, NHCOOQ, NHCONHQ, OCOOQ, CN, CON(Q)₂, CO(N-heterocycle), NO, NO₂, N(Q)₂, SO₃H, SO₃M, SO₂Q, SO₂M, SOQ, PO(OH)₂ and OPO(OH)₂;
Q² each is independently selected from H, halide, haloalkyl tosylate, mesylate, SO₂NHQ, triflate, isocyante, cyanate, thiocyanate, isothiocyanate, COQ, COCl, COOCOQ, COOQ, OCOQ, OCONHQ, NHCOOQ, NHCONHQ, OCOOQ, CN, CON(Q)₂, CO(N-heterocycle), NO, NO₂, N(Q)₂, SO₃H, SO₃M, SO₂Q, SO₂M, SOQ, PO(OH)₂ and OPO(OH)₂;
Q³, Q^{3′}, Q¹⁵ and Q^{15′} are each independently selected from H, alkyl, cycloalkyl, heterocycloalkyl, aryl, benzyl, halide, NO₂, OQ, N(Q)₂, COQ, CN, CON(Q)₂, CO(N-Heterocycle) and COOQ;
Q⁸, Q⁸, Q¹⁰ and C^{10′} are each independently selected from absent, H, alkyl, cycloalkyl, heterocycloalkyl, aryl, benzyl, halide, NO₂, OQ, N(Q)₂, COQ, CN, CON(Q)₂, CO(N-Heterocycle) and COOQ;
Q⁴-Q⁶, Q⁹, Q^{9′}, Q¹²-Q¹⁴, Q^{4′}-Q^{6′} and Q^{12′}-Q^{14′} are each independently selected from H, alkyl, cycloalkyl, heterocycloalkyl, aryl, benzyl, halide, NO₂, OQ, N(Q)₂, COQ, CN, CON(Q)₂, CO(N-heterocycle) and COOQ;
Q⁷, Q^{7′}, Q¹¹ and Q^{11′} are each independently selected from absent, H, alkyl, cycloalkyl, heterocycloalkyl, aryl, benzyl, halide, NO₂, OQ, N(Q)₂, COQ, CN, CON(Q)₂, CO(N-heterocycle) and COOQ;
Q is H, alkyl, cycloalkyl, heterocycloalkyl, aryl, benzyl, —(CH₂CH₂O)ᵣCH₂CH₂OH, —(CH₂)ₚOC(O)NH(CH₂)_{q}Si(Oalkyl)₃, —(CH₂)ₚOC(O)CH═CH₂, —(CH₂)_{P}OC(O)C(CH₃)═CH₂ or —(CH₂)ₚSi(Oalkyl)₃;
Z¹⁰¹ is O, CQ₂ or SiQ₂;
M is a monovalent cation;
s and t are independently an integer between 1-4;
p and q are independently an integer between 1-6;
r is an integer between 0-10;
X is an anion;
wherein if there is double bond between the carbons which are substituted by Q⁷, Q^{7′}, Q⁸ and Q^{8′}—then Q⁷ and Q⁸ are absent or Q⁷ and Q^{8′} are absent or Q^{7′} and Q⁸ are absent or Q^{7′} and R^{8′} are absent; and
wherein if there is double bond between the carbons which are substituted by Q¹⁰, Q^{10′}, Q¹¹ and Q^{11′}—then Q¹⁰ and Q¹¹ are absent or Q¹⁰ and Q^{11′} are absent or Q^{10′} and Q¹¹ are absent or Q^{10′} and Q^{11′} are absent.

In certain embodiments, carbo-rhodamines and/or silicon rhodamines disclosed herein may provide examples for dyes 115 that convert near IR to far IR radiation.

Additional chemical species which are based on Formula 1 and 2 are provided in WIPO Publication No. WO 2018/042437 and U.S. Publication Nos. 2018/0072892 and 2018/0039131, which are incorporated herein by reference in their entirety.

The positions of R¹, (R²)ₙ and (R³)ₘ may be selected to be any feasible position with respect to the indicated ring. Any of R¹, (R²)ₙ and (R³)ₘ may be positioned at ortho, meta or para positions with respect to the rest of the molecule, as long as the resulting structure is chemically feasible. Precursors and formulations for using dyes 115 in color conversion units and/or in color conversion inks may be adapted to accommodate and support embodiments of the selected dyes according to the principles disclosed herein.

Specific, non-limiting, examples of dyes 115 which were tested below include compounds denoted ES61, JK32 (shown as JK-32A and/or JK-32B), RS56 (shown as RS56A and/or RS56B), RS106 and RS130, ESI 18 and ES144.

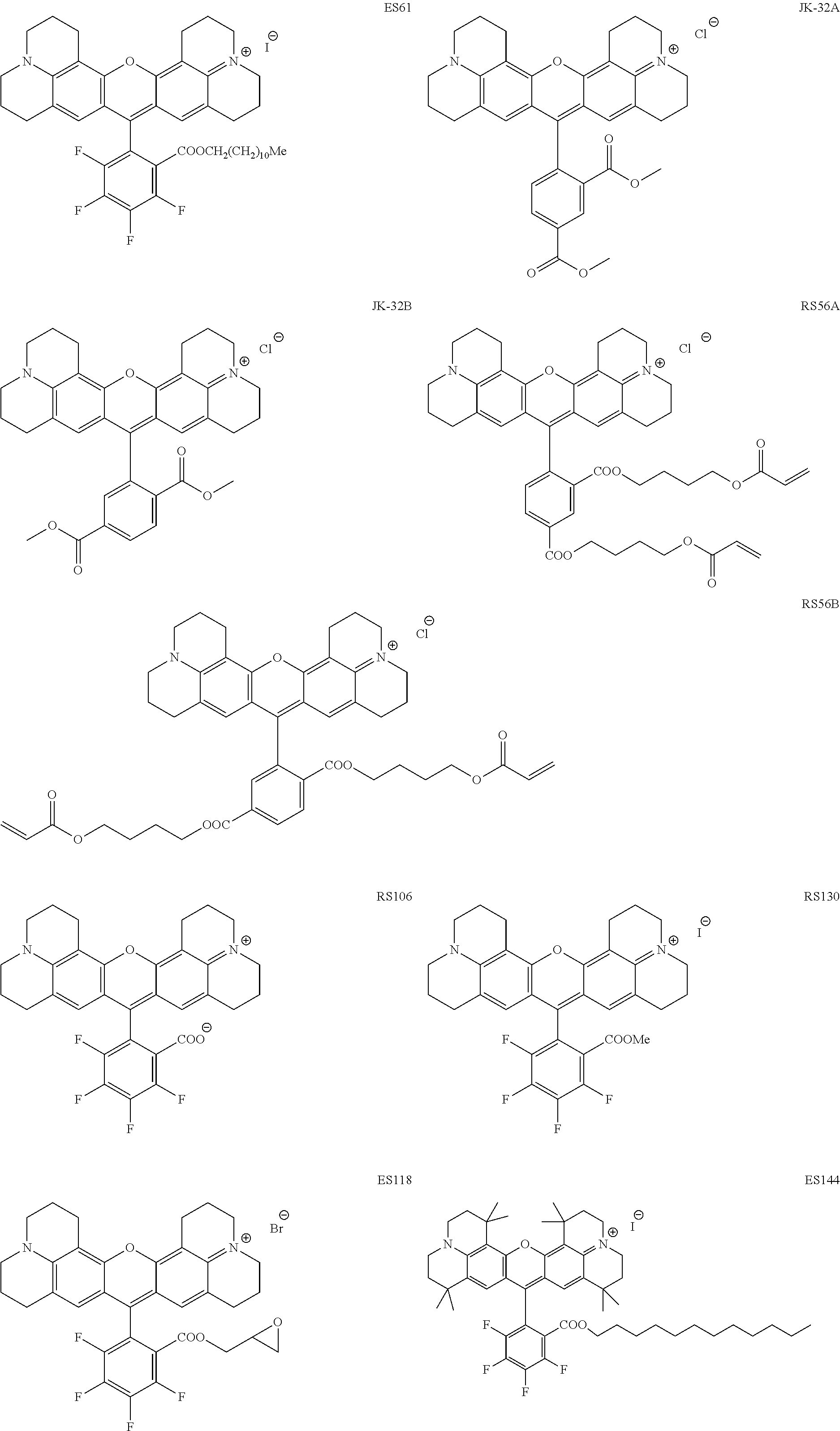

Some embodiments of dyes 115 are presented in more detail in U.S. Publication Nos. 2018/0072892 and 2018/0039131, and U.S. Pat. No. 9,771,480 and are considered likewise part of the present disclosure. Non-limiting examples are provided in the following variants, numbered 1-11, 9a, 10a, 11a, 20 and 23-26.

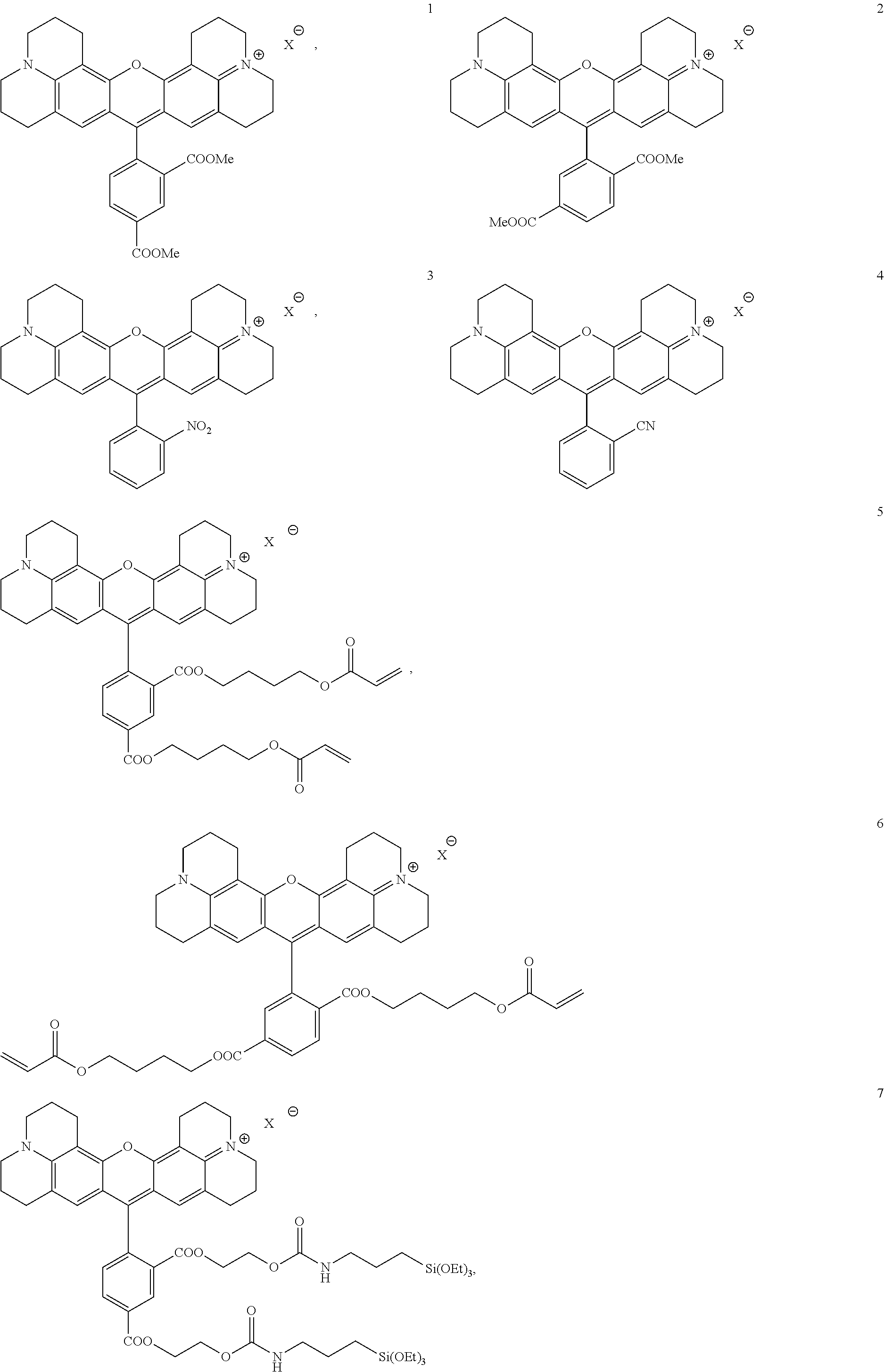

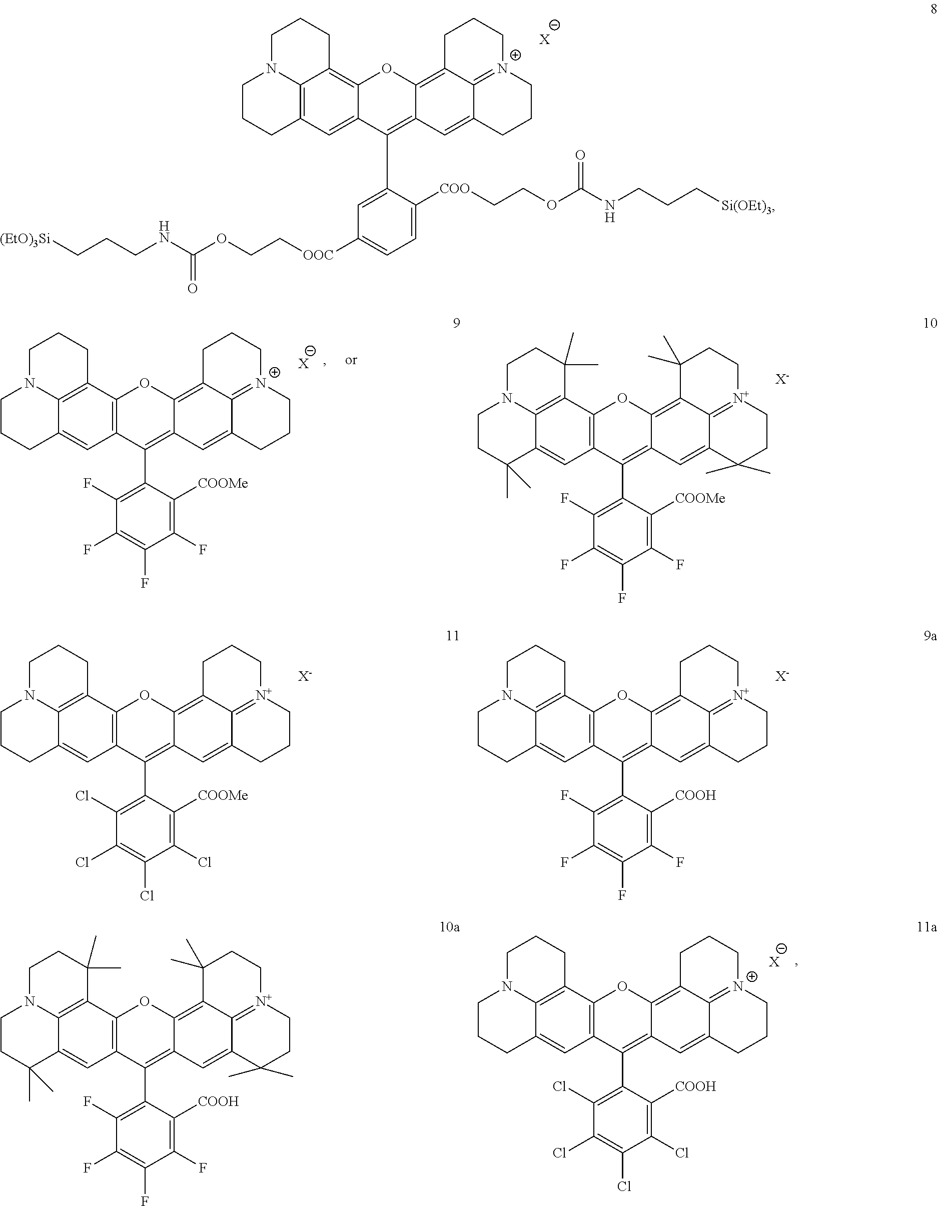

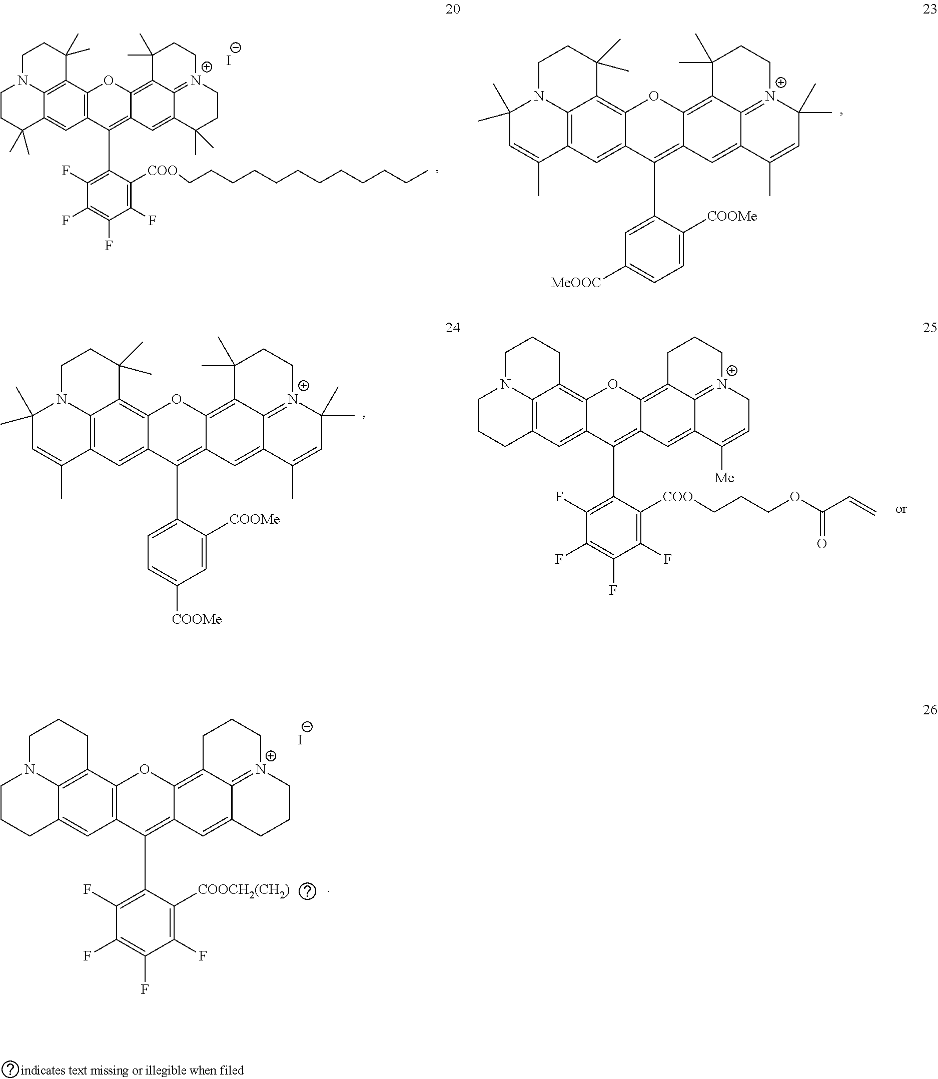

Some embodiments of fluorescent dyes 115 are defined by Formula 3.

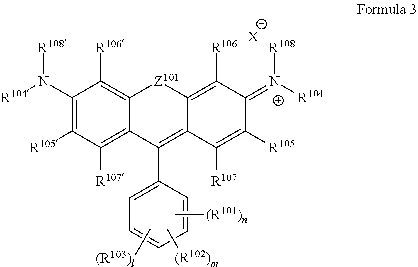

wherein
R¹⁰¹ each is independently H, Q¹⁰¹, OQ¹⁰¹, C(O)Q¹⁰¹, NQ¹⁰¹Q¹⁰², NO₂, CN, SQ¹⁰¹, —NQ¹⁰¹Q¹⁰²CONQ¹⁰³Q¹⁰⁴, NCO, NCS, —OC(O)OQ¹⁰¹ or halide;
R¹⁰² each is independently H, Q¹⁰¹, OQ¹⁰¹, C(O)Q¹⁰¹, NQ¹⁰¹Q¹⁰², NO₂, CN, SQ¹⁰¹, —NQ¹⁰¹Q¹⁰²CONQ¹⁰³Q¹⁰⁴, NCO, NCS, —OC(O)OQ¹⁰¹ or halide;
R¹⁰³ each is independently H, Q¹⁰¹, OQ¹⁰¹, C(O)Q¹⁰¹, NQ¹⁰¹Q¹⁰², NO₂, CN, SQ¹⁰¹, —NQ¹⁰¹Q¹⁰²CONQ¹⁰³Q¹⁰⁴, NCO, NCS, —OC(O)OQ¹⁰¹ or halide;
R¹⁰⁴, R^{104′}, R¹⁰⁸ and R^{108′} are each independently selected from H, alkyl, haloalkyl, heterocycloalkyl, cycloalkyl, aryl and benzyl;
R¹⁰⁵ and R^{105′} are each independently selected from H, Z′, OQ¹⁰¹, C(O)Q¹⁰¹, COOQ¹⁰¹, CON(Q¹⁰¹)₂, NQ¹⁰¹Q¹⁰², NO₂, CN, SO_{3′}, SO₃M, SO₃H, SQ¹⁰¹, —NQ¹⁰¹Q¹⁰²CONQ¹⁰³Q¹⁰⁴, NCO, NCS, alkenyl, alkynyl, epoxide, alkylated epoxide, alkylated azide, azide and halide;
R¹⁰⁶, R^{106′}, R¹⁰⁷ and R^{107′} are each independently selected from H, Q¹⁰¹, OQ¹⁰¹, C(O)Q¹⁰¹, COOQ¹⁰¹, CON(Q¹⁰¹)₂, NQ¹⁰¹Q¹⁰², NO₂, CN, SO₃⁻, SO₃M, SO₃H, SQ¹⁰¹, —NQ¹⁰¹Q¹⁰²CONQ¹⁰³Q¹⁰⁴, NCO, NCS, alkenyl, alkynyl, epoxide, alkylated epoxide, alkylated azide, azide and halide;
R¹⁰⁴ and R¹⁰⁵, R^{104′} and R^{105′}, R¹⁰⁴ and R¹⁰⁸ or R^{104′} and R^{108′} may form together an N-heterocyclic ring wherein said ring is optionally substituted;
Q¹⁰¹ and Q¹⁰² are each independently selected from H, alkyl, haloalkyl, heterocycloalkyl, cycloalkyl, aryl, benzyl, —(CH₂)ₚOC(O)NH(CH₂)_{q}Si(Oalkyl)₃, —(CH₂)ₚOC(O)CH═CH₂, —(CH₂)_{P}OC(O)C(CH₃)═CH₂, —(CH₂)_{P}Si(Oalkyl)₃, —(CH₂)ₚOC(O)NH(CH₂)_{q}Si(halide)₃, —(CH₂)ₚSi(halide)₃, —OC(O)N(H)Q¹⁰⁴, —OC(S)N(H)Q¹⁰⁴, —N(H)C(O)N(Q¹⁰³)₂ and —N(H)C(S)N(Q¹⁰³)₂;
Z¹⁰¹ is O, CQ¹⁰³₂ or SiQ¹⁰³₂;
Z′ is selected from alkyl, haloalkyl, heterocycloalkyl, cycloalkyl, aryl, benzyl, —(CH₂)ₚOC(O)NH(CH₂)_{q}Si(Oalkyl)₃, —(CH₂)ₚOC(O)CH═CH₂, (CH₂)ₚOC(O)C(CH₃)═CH₂, —(CH₂)ₚSi(Oalkyl)₃, —(CH₂)ₚOC(O)NH(CH₂)_{q}Si(halide)₃, —(CH₂)ₚSi(halide)₃, —OC(O)N(H)Q¹⁰⁴, —OC(S)N(H)Q¹⁰⁴, —N(H)C(O)N(Q¹⁰³)₂ and —N(H)C(S)N(Q¹⁰³)₂;
Q¹⁰³ and Q¹⁰⁴ are each independently selected from H, alkyl, haloalkyl, heterocycloalkyl, cycloalkyl, aryl and benzyl;
M is a monovalent cation;
n, m and l are independently an integer between 1-5;
p and q are independently an integer between 1-6; and
X is an anion.

Additional chemical species which are based on Formula 2 are provided in WIPO Publication No. WO 2018/042437 and U.S. Publication Nos. 2018/0072892 and 2018/0039131, which are incorporated herein by reference in their entirety. For example, certain embodiments having R¹⁰⁸═H are provided in these applications and are incorporated herein by reference in their entirety. Also, certain embodiments having R¹⁰⁶, R^{106′}, R¹⁰⁷, R^{107′}, R¹⁰⁸ and R^{108′} as H are provided in these applications and are incorporated herein by reference in their entirety, as well as embodiments with R¹⁰⁵ and R^{105′} being F, R¹⁰⁴ and R^{104′} being CF₃, and various examples.

Specific, non-limiting, examples of green-fluorescent dyes 115 of the invention include compounds represented by the structures below, denoted as JK71 and RS285.

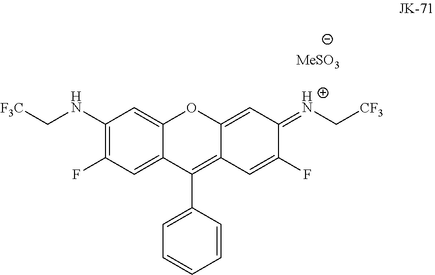

### (Z)—N-(2,7-difluoro-9-phenyl-6-((2,2,2-trifluoroethyl)amino)-3H-xanthen-3-ylidene)-2,2,2-trifluoroethan-1-aminium methanesulfonate

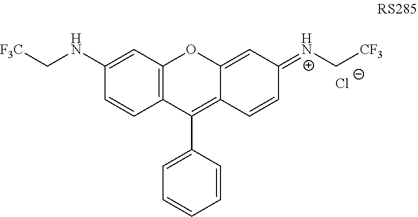

Some embodiments of dyes 115 are presented in more detail in U.S. Publication Nos. 2018/0057688, 2018/0072892 and 2018/003913 land are considered likewise part of the present disclosure. Non-limiting examples are provided in the following variants, numbered 12-19 and 21-22.

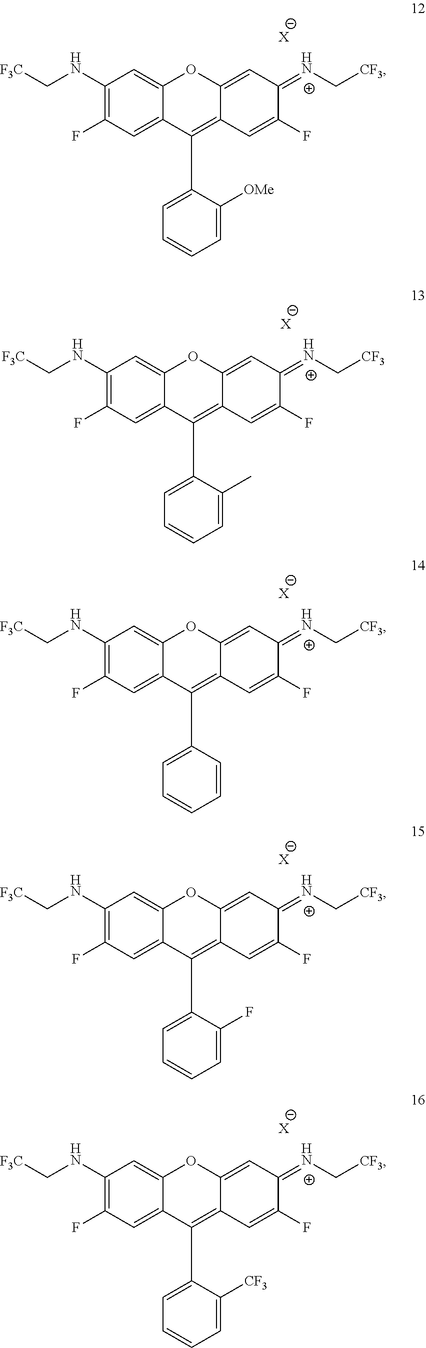

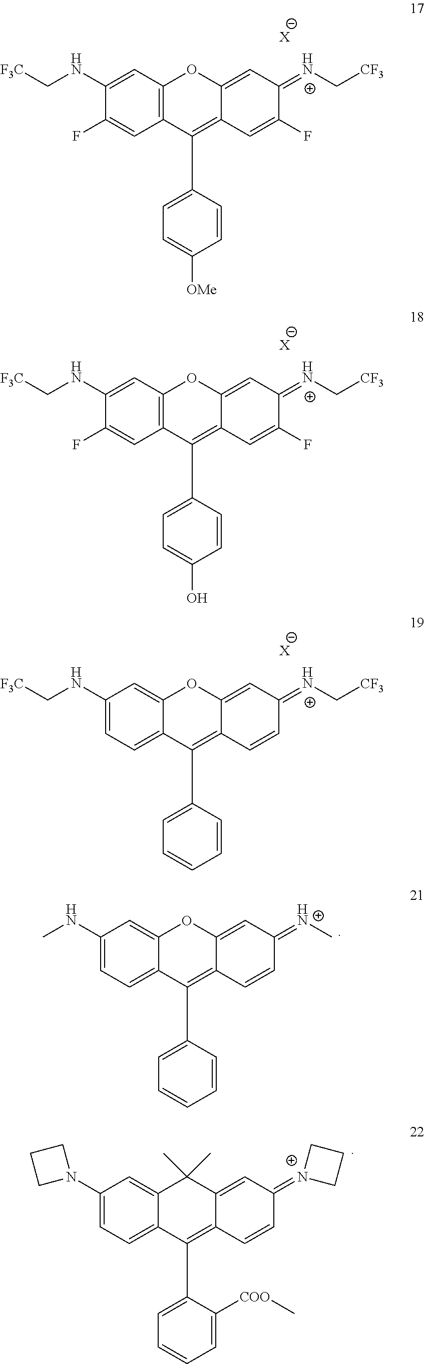

Some embodiments of fluorescent dyes 115 are defined by Formula 4.

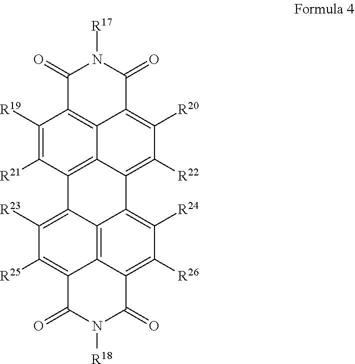

wherein
R¹⁷-R¹⁸ are each independently H, haloalkyl, alkyl, cycloalkyl, heterocycloalkyl, aryl or benzyl; and
R¹⁹-R²⁶ are each independently selected from H, alkyl, alkenyl, alkynyl, epoxide, alkylated epoxide, azide, cycloalkyl, heterocycloalkyl, aryl, benzyl, halide, NO₂, SR¹⁷, OR¹⁷, N(R¹⁷)₂, COR¹⁷, CN, CON(R¹⁷)₂, CO(N-heterocycle) and COOR¹⁷.

Fluorescent dyes 115 defined by Formula 4 comprise PDIs (preylene diimide) dye which have a very good photo stability and high quantum yields.

An “alkyl” group refers, in some embodiments, to a saturated aliphatic hydrocarbon, including straight-chain or branched-chain. In some embodiments, alkyl is linear or branched. In another embodiment, alkyl is optionally substituted linear or branched. In another embodiment, alkyl is methyl. In another embodiment alkyl is ethyl. In some embodiments, the alkyl group has 1-20 carbons. In another embodiment, the alkyl group has 1-8 carbons. In another embodiment, the alkyl group has 1-7 carbons. In another embodiment, the alkyl group has 1-6 carbons. In another embodiment, non-limiting examples of alkyl groups include methyl, ethyl, propyl, isobutyl, butyl, pentyl or hexyl. In another embodiment, the alkyl group has 1-4 carbons. In another embodiment, the alkyl group may be optionally substituted by one or more groups selected from halide, hydroxy, alkoxy, carboxylic acid, aldehyde, carbonyl, amido, cyano, nitro, amino, alkenyl, alkynyl, aryl, azide, epoxide, ester, acyl chloride and thiol. Each possibility represents a separate embodiment of this invention.

A “cycloalkyl” group refers, in some embodiments, to a ring structure comprising carbon atoms as ring atoms, which are saturated, substituted or unsubstituted. In another embodiment, the cycloalkyl is a 3-12 membered ring. In another embodiment, the cycloalkyl is a 6 membered ring. In another embodiment, the cycloalkyl is a 5-7 membered ring. In another embodiment, the cycloalkyl is a 3-8 membered ring. In another embodiment, the cycloalkyl group may be unsubstituted or substituted by a halogen, alkyl, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In another embodiment, the cycloalkyl ring may be fused to another saturated or unsaturated 3-8 membered ring. In another embodiment, the cycloalkyl ring is an unsaturated ring. Non limiting examples of a cycloalkyl group comprise cyclohexyl, cyclohexenyl, cyclopropyl, cyclopropenyl, cyclopentyl, cyclopentenyl, cyclobutyl, cyclobutenyl, cycloctyl, cycloctadienyl (COD), cycloctaene (COE) etc. Each possibility represents a separate embodiment of this invention.

A “heterocycloalkyl” group refers in some embodiments, to a ring structure of a cycloalkyl as described herein comprising in addition to carbon atoms, sulfur, oxygen, nitrogen or any combination thereof, as part of the ring. In some embodiments, non-limiting examples of heterocycloalkyl include pyrrolidine, pyrrole, tetrahydrofuran, furan, thiolane, thiophene, imidazole, pyrazole, pyrazolidine, oxazidione, oxazole, isoxazole, thiazole, isothiazole, thiazolidine, dioxolane, dithiolane, triazole, furazan, oxadiazole, thiadiazole, dithiazole, tetrazole, piperidine, oxane, thiane, pyridine, pyran, thiopyran, piperazine, morpholine, thiomorpholine, dioxane, dithiane, diazine, oxazine, thiazine, dioxine, triazine, and trioxane. Each possibility represents a separate embodiment of this invention.

As used herein, the term “aryl” refers to any aromatic ring that is directly bonded to another group and can be either substituted or unsubstituted. The aryl group can be a sole substituent, or the aryl group can be a component of a larger substituent, such as in an arylalkyl, arylamino, arylamido, etc. Exemplary aryl groups include, without limitation, phenyl, tolyl, xylyl, furanyl, naphthyl, pyridinyl, pyrimidinyl, pyridazinyl, pyrazinyl, triazinyl, thiazolyl, oxazolyl, isooxazolyl, pyrazolyl, imidazolyl, thiophene-yl, pyrrolyl, phenylmethyl, phenylethyl, phenylamino, phenylamido, etc. Substitutions include but are not limited to: F, Cl, Br, I, C₁-C₅ linear or branched alkyl, C₁-C₅ linear or branched haloalkyl, C₁-C₅ linear or branched alkoxy, C₁-C₅ linear or branched haloalkoxy, CF₃, CN, NO₂, —CH₂CN, NH₂, NH-alkyl, N(alkyl)₂, hydroxyl, —OC(O)CF₃, —OCH₂Ph, —NHCO-alkyl, COOH, —C(O)Ph, C(O)O-alkyl, C(O)H, or - or —C(O)NH₂. Each possibility represents a separate embodiment of this invention.

N-heterocycle refers to in some embodiments, to a ring structure comprising in addition to carbon atoms, a nitrogen atom, as part of the ring. In another embodiment, the N-heterocycle is a 3-12 membered ring. In another embodiment, the N-heterocycle is a 6 membered ring. In another embodiment, the N-heterocycle is a 5-7 membered ring. In another embodiment, the N-heterocycle is a 3-8 membered ring. In another embodiment, the N-heterocycle group may be unsubstituted or substituted by a halogen, alkyl, haloalkyl, hydroxyl, alkoxy, carbonyl, amido, alkylamido, dialkylamido, cyano, nitro, CO₂H, amino, alkylamino, dialkylamino, carboxyl, thio and/or thioalkyl. In another embodiment, the heterocycle ring may be fused to another saturated or unsaturated cycloalkyl or heterocyclic 3-8 membered ring. In another embodiment, the N-heterocyclic ring is a saturated ring. In another embodiment, the N-heterocyclic ring is an unsaturated ring. Non limiting examples of N-heterocycle comprise pyridine, piperidine, morpholine, piperazine, pyrrolidine, pyrrole, imidazole, pyrazole, pyrazolidine, triazole, tetrazole, piperazine, diazine, or triazine. Each possibility represents a separate embodiment of this invention.

In some embodiments, the term “halide” used herein refers to any substituent of the halogen group (group 17). In another embodiment, halide is fluoride, chloride, bromide or iodide. In another embodiment, halide is fluoride. In another embodiment, halide is chloride.

In another embodiment, halide is bromide. In another embodiment, halide is iodide. Each possibility represents a separate embodiment of this invention.

In some embodiments, haloalkyl is partially halogenated alkyl. In another embodiment haloalkyl is perhalogenated alkyl (completely halogenated, no C—H bonds). In another embodiment, haloalkyl refers to alkyl, alkenyl, alkynyl or cycloalkyl substituted with one or more halide atoms. In another embodiment, haloalkyl is CH₂CF₃. In another embodiment, haloalkyl is CH₂CCl₃. In another embodiment, haloalkyl is CH₂CBr₃. In another embodiment, haloalkyl is CH₂CI₃. In another embodiment, haloalkyl is CF₂CF₃. In another embodiment, haloalkyl is CH₂CH₂CF₃. In another embodiment, haloalkyl is CH₂CF₂CF₃. In another embodiment, haloalkyl is CF₂CF₂CF₃. Each possibility represents a separate embodiment of this invention.

In some embodiments, the term “alkenyl” used herein refers to any alkyl group wherein at least one carbon-carbon double bond (C═C) is found. In another embodiment, the carbon-carbon double bond is found in one terminal of the alkenyl group. In another embodiment, the carbon-carbon double bond is found in the middle of the alkenyl group. In another embodiment, more than one carbon-carbon double bond is found in the alkenyl group. In another embodiment, three carbon-carbon double bonds are found in the alkenyl group. In another embodiment, four carbon-carbon double bonds are found in the alkenyl group. In another embodiment, five carbon-carbon double bonds are found in the alkenyl group. In another embodiment, the alkenyl group comprises a conjugated system of adjacent alternating single and double carbon-carbon bonds. In another embodiment, the alkenyl group is a cycloalkenyl, wherein “cycloalkenyl” refers to a cycloalkyl comprising at least one double bond. Each possibility represents a separate embodiment of this invention.

In some embodiments, the term “alkynyl” used herein refers to any alkyl group wherein at least one carbon-carbon triple bond (C≡C) is found. In another embodiment, the carbon-carbon triple bond is found in one terminal of the alkynyl group. In another embodiment, the carbon-carbon triple bond is found in the middle of the alkynyl group. In another embodiment, more than one carbon-carbon triple bond is found in the alkynyl group. In another embodiment, three carbon-carbon triple bonds are found in the alkynyl group. In another embodiment, four carbon-carbon triple bonds are found in the alkynyl group. In another embodiment, five carbon-carbon triple bonds are found in the alkynyl group. In another embodiment, the alkynyl group comprises a conjugated system. In another embodiment, the conjugated system is of adjacent alternating single and triple carbon-carbon bonds. In another embodiment, the conjugated system is of adjacent alternating double and triple carbon-carbon bonds. In another embodiment, the alkynyl group is a cycloalkynyl, wherein “cycloalkynyl” refers to a cycloalkyl comprising at least one triple bond. Each possibility represents a separate embodiment of this invention.

In some embodiments, the term “alkylated azide” used herein refers to any alkylated substituent comprising an azide group (—N₃). In another embodiment, the azide is in one terminal of the alkyl. In another embodiment, the alkyl is a cycloalkyl. In another embodiment, the alkyl is an alkenyl. In another embodiment, the alkyl is an alkynyl. In another embodiment, the epoxide is monoalkylated.

In some embodiments, the term “alkylated epoxide” used herein refers to any alkylated substituent comprising an epoxide group (a 3-membered ring consisting of oxygen and two carbon atoms). In another embodiment, the epoxide group is in the middle of the alkyl. In another embodiment, the epoxide group is in one terminal of the alkyl. In another embodiment, the alkyl is a cycloalkyl. In another embodiment, the alkyl is an alkenyl. In another embodiment, the alkyl is an alkynyl. In another embodiment, the epoxide is monoalkylated. In another embodiment, the epoxide is dialkylated. In another embodiment, the epoxide is trialkylated. In another embodiment, the epoxide is tetraalkylated.

In some embodiments, the notion of “ [symbol] ” of a bond within any of the disclosed structures of the current invention refers to a carbon-carbon single bond (“ [symbol] ”) or a carbon-carbon double bond (“ [symbol] ”). In some embodiments, each structure in any of the disclosed structures of the current invention comprise two [symbol] bonds. In another embodiment, each structure comprises two [symbol] bonds that are selected to be two single bonds, two double bonds, one single and one double bond or one double and one single bond, each represents a separate embodiment of this invention.

Films may be produced to include dyes 115 in various technologies, such as Sol-gel processes and UV curing processes—disclosed in U.S. Patent Application Publication No. 2018/0246371 that is incorporated herein by reference in its entirety. Any production process disclosed in U.S. Patent Application Publication No. 2018/0246371 may be applied herein with respect to dyes 115. In various embodiments, dyes 115 may be associated with polymers and/or with nanoparticles as disclosed in U.S. Patent Application Publication No. 2018/0246371, to provide a carrier for the dye molecules in the color conversion ink and/or in the color conversion units. Protective films as disclosed in U.S. Patent Application Publication No. 2018/0246371 may also be part of color conversion unit(s) 110.

Aspects of the present invention are described above with reference to flowchart illustrations and/or portion diagrams of methods, apparatus (systems) and computer program products according to embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram or portions thereof.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram or portions thereof.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram or portions thereof.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the invention. The various appearances of “one embodiment”, “an embodiment”, “certain embodiments” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention may also be implemented in a single embodiment. Certain embodiments of the invention may include features from different embodiments disclosed above, and certain embodiments may incorporate elements from other embodiments disclosed above. The disclosure of elements of the invention in the context of a specific embodiment is not to be taken as limiting their use in the specific embodiment alone. Furthermore, it is to be understood that the invention can be carried out or practiced in various ways and that the invention can be implemented in certain embodiments other than the ones outlined in the description above.

The invention is not limited to those diagrams or to the corresponding descriptions. For example, flow need not move through each illustrated box or state, or in exactly the same order as illustrated and described. Meanings of technical and scientific terms used herein are to be commonly understood as by one of ordinary skill in the art to which the invention belongs, unless otherwise defined. While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A color conversion unit for horticultural applications, the color conversion unit comprising:
at least one structural element, configured to be positioned between at least one illumination source having a specified spectrum and a horticultural crop, and
at least one fluorescent dye embedded in the at least one structural element, the at least one fluorescent dye configured to convert radiation within at least one absorption range of the specified spectrum into emitted radiation within at least one emission range that is at longer wavelengths than the at least one absorption range.

2. The color conversion unit of claim 1, wherein the at least one structural element comprises at least one greenhouse structural element.

3. The color conversion unit of claim 1, wherein the at least one structural element is attachable to at least one greenhouse structural element.

4. A greenhouse, comprising the color conversion unit of claim 1 within and/or attached to structural elements thereof including roof and/or walls.

5. The greenhouse of claim 4, further comprising shading means, wherein the color conversion unit is configured to maximize useful illumination when the shading means are applied.

6. The color conversion unit of claim 1, wherein the at least one illumination source comprises sunlight illumination, and the at least one fluorescent dye is selected to convert the solar illumination spectrum into a spectrum that is more similar to an absorption spectrum of the crop.

7. The color conversion unit of claim 1, wherein the at least one illumination source comprises artificial illumination, and the at least one fluorescent dye is selected to convert the artificial illumination spectrum into a spectrum that is more similar to an absorption spectrum of the crop.

8. A plurality of color conversion units of claim 7, each configured to convert the artificial illumination spectrum into a different spectrum.

9. An illuminator comprising the color conversion unit of claim 7 within and/or attached to at least one structural element thereof.

10. The color conversion unit of claim 1, wherein the at least one fluorescent dye is selected to convert any of: blue and/or green light into red light, ultraviolet radiation into visible light, red light into infrared radiation and/or near infrared radiation into far infrared radiation.

11. The color conversion unit of claim 1, wherein the at least one fluorescent dye is selected to modify heat transfer to the plants, by converting near IR radiation to far IR radiation, reducing heat load.

12. The color conversion unit of claim 1, wherein the at least one absorption range is selected as one or more spectral range in which radiation is stronger than a capability of the crop to absorb, during at least one period, and wherein the at least one emission range is selected as one or more spectral range in which radiation is weaker than a capability of the crop to absorb, during the same at least one period.

13. The color conversion unit of claim 1, wherein the at least one absorption range and the at least one emission range are selected to modify an illumination-related growth signal for the crop.

14. A crop growing system comprising the color conversion unit of claim 1 associated with at least one artificial illumination source.

15. The crop growing system of claim 14, further comprising a closed-loop controller configured to modify the at least one fluorescent dye and/or modify parameters of the at least one structural element with respect to plant requirements and artificial illumination source parameters.

16. A crop growing system comprising the color conversion unit of claim 1 and at least one artificial illumination source that is used in addition to sunlight illumination.

17. The crop growing system of claim 16, wherein the color conversion unit is associated with at least one of the artificial and sunlight illumination.

18. The crop growing system of claim 17, further comprising a closed-loop controller configured to modify the at least one fluorescent dye and/or modify parameters of the at least one structural element with respect to plant requirements and sunlight and artificial illumination source parameters.

19. A color conversion ink for horticultural applications, the color conversion ink comprising at least one fluorescent dye configured to convert radiation within at least one absorption range of a specified illumination spectrum into emitted radiation within at least one emission range that is at longer wavelengths than the at least one absorption range, wherein the color conversion ink is configured to be paintable on at least one structural element, configured to be positioned between at least one illumination source having the specified illumination spectrum and a horticultural crop; and/or wherein the color conversion ink is configured to be paintable on the at least one illumination source illuminating the horticultural crop.

20. The color conversion ink of claim 19, wherein the at least one fluorescent dye is selected to convert any of: blue and/or green light into red light, ultraviolet radiation into visible light, red light into infrared radiation and/or near infrared radiation into far infrared radiation.

21. A method of improving crop illumination in horticultural applications, the method comprising:
using at least one fluorescent dye to convert radiation within at least one absorption range of a specified illumination spectrum into emitted radiation within at least one emission range that is at longer wavelengths than the at least one absorption range, and
associating the at least one fluorescent dye with at least one structural element, configured to be positioned between at least one illumination source having the specified illumination spectrum and a horticultural crop.

22. The method of claim 21, wherein the associating is carried out by embedding the at least one fluorescent dye in the at least one structural element and/or painting the at least one fluorescent dye onto the at least one structural element.

23. The method of claim 21, further comprising modifying the at least one fluorescent dye and/or parameters of the at least one structural element with respect to plant requirements and illumination source parameters.
